(19) United States
(12) Patent Application Publication
(10) Pub. No.: US 2016/0316535 A1
(43) Pub. Date: Oct. 27, 2016

(54) APPARATUS AND METHOD FOR AUTOMATIC CHARACTERIZATION AND CONFIGURATION OF AN LED LIGHTING SYSTEM

(71) Applicant: FABRIQ, LTD., Boulder, CO (US)

(72) Inventors: JEFFREY G. REH, Longmont, CO (US); MATTHEW B. O'KELLEY, Boulder, CO (US)

(21) Appl. No.: 15/139,085

(22) Filed: Apr. 26, 2016

Related U.S. Application Data
(60) Provisional application No. 62/153,023, filed on Apr. 27, 2015.

(51) Int. Cl. H05B 33/08

(52) U.S. Cl. CPC H05B 33/0842; H05B 33/0806

(57) ABSTRACT

An apparatus for automatically characterizing and configuring a light-emitting diode (LED) lighting system is provided. The apparatus includes a driver, an identification element, and an exciter. The driver is configured to provide a plurality of constant currents within a first range, a plurality of first voltages within a second range, at a plurality of maximum power levels within a third range over a power signal and a return signal, where the driver is configurable to drive the power and return signals to provide one of the plurality of constant currents, one of the first plurality of first voltages, and one of the plurality of maximum power levels to comport with operating characteristics of an LED module. The identification element is coupled to the driver, and is configured to exhibit a unique frequency response to excitation by excitation signals generated exclusively over the power and return signals at second voltages less than a lower bound of the second range. The exciter is coupled to the identification element and the driver via the power and return signals, and is configured to generate the excitation signals, and is configured to determine the one of the plurality of constant currents, the one of the plurality of first voltages, and the one of the plurality of maximum power levels based upon the unique frequency response, and is configured to configure the driver to comport with the operating characteristics.

### CROSS-REFERENCE TO RELATED APPLICATIONS

This application claims the benefit of the following U.S. Provisional Application, which is herein incorporated by reference for all intents and purposes.

| SER. | FILING | |
|---|---|---|
| NO. | DATE | TITLE |
| 62/153,023 | Apr. 27, 2015 | APPARATUS AND METHOD |
| (FBQ.1010) | | FOR AUTOMATIC |
| | | CHARACTERIZATION AND |
| | | CONFIGURATION OF |
| | | AN LED LIGHTING SYSTEM |

### BACKGROUND OF THE INVENTION

1. Field of the Invention

This invention relates in general to the field of lighting, and more particularly to an apparatus and method for automatic characterization and configuration of a light-emitting diode (LED) lighting system.

2. Description of the Related Art

LED lighting systems are becoming increasingly more prevalent in new building designs as well as in retrofits for existing fluorescent and incandescent systems because of their low power usage and long lifetimes. In any size building (i.e., small, medium, large), one can look up and see a grid of, say, 2-foot by 4-foot lighting panels that used to contain fluorescent bulbs, but now in which are disposed LED lighting modules. Yet, because of lack of standardization, there are a plethora of different types of LED modules having different drive currents, voltages, and maximum power ratings, along with LED drivers that are matched to corresponding LED modules that provide for driving the LED modules at corresponding drive currents, voltages, and maximum power ratings. The present inventors have observed that the sheer number of different types of LED modules, along with their corresponding LED drivers is disadvantageous from many perspectives, most notably stocking and installation. Accordingly, the present application addresses these problems, and other disadvantages and limitations related to selecting and configuring LED drivers so that they may safely and reliably control LED modules to which they are connected.

Consequently, there is an increasing demand in the art for a cost-effective, “universal” LED driver, namely an LED driver that can be employed in most, if not all, LED lighting configurations. Presently, when an LED lighting system for a facility is configured, a system designer will select LED modules from a particular manufacturer, or the LED modules may be selected from a plurality of different manufacturers, according to lighting requirements and constraints for the facility. Because present day LED modules are not subject to standardized drive requirements, the system designer must also search for and match LED drivers to the LED modules that have been chosen. This process can also occur in reverse order as well. That is, the system designer may select LED drivers first, and then choose LED modules that comport with the parameters of the selected LED drivers, while satisfying lighting requirements and constraints for the facility. As one skilled in the art will appreciate, LED modules from different manufacturers exhibit a remarkable number of different parameters and operating characteristics including, but not limited to, lumen output, correlated color temperature (CCT), maximum and minimum drive current, maximum voltage, and maximum power. Accordingly, the manufacturers of LED drivers (or third party manufacturers) must also design and produce numerous different LED drivers that match the parameters and operating characteristics of the LED modules. Thus, as alluded to above, the present inventors have noted that present day LED lighting technologies and products are limiting because a cornucopia of LED drivers have been fielded to accommodate a substantial number of LED modules having substantially different drive requirements.

In more recent years, some LED driver manufacturers have been able to field LED drivers that may be configured to drive a variety of different LED modules having different parameters and operating characteristics. Configuration of these LED drivers is typically achieved via setting the positions of mechanical switches, whether at the factory or on site.

More recently, LED drivers have been fielded that may be configured by programming non-volatile memories that are part of the LED drivers. In both cases, mechanical and non-volatile memory, once an LED driver has been configured/programmed, it can only drive an LED module that comports with the configured/programmed parameters and operating characteristics. This is another disadvantage in the art which has been noted by the present inventors, primarily because of the expense associated with manufacturing, stocking, maintaining and cataloging an increasing number of LED module/LED driver variants.

Present day programmable LED drivers, as alluded to above, are an improvement, but the spectrum of LED modules that these programmable drivers support is limited. They are limited because configuration of the drivers is typically achieved via mechanical switches or non-volatile memory, which limits the number of different parameters and operating characteristics that a given LED driver can achieve.

Another disadvantage of present day LED lighting technologies is that programmable LED drivers must be stocked in their unconfigured state, and subsequently must be configured to match corresponding LED module drive requirements, either before shipping or during installation. A further disadvantage is that when an LED module or LED driver fails during installation, the LED module or LED driver must be replaced by an equivalent LED module or LED driver, either from the same manufacturer, or one that that is equivalent in terms of operating characteristics. As one skilled in the art will appreciate, if the operating characteristics of a substitute LED module or LED driver are slightly different from the failed LED module or LED driver, then premature failure of the newly installed LED module or LED driver can occur or, worse, fire hazard can ensue.

Therefore, what is needed is an inexpensive and cost-effective technique for automatically identifying parameters and operating characteristics of an LED module for purposes of configuring a corresponding LED driver.

What is also needed is a mechanism for configuring an LED driver without human intervention to match desired parameters and operating characteristics of a corresponding LED module to which the LED driver is coupled.

What is further needed is an LED driver that automatically determines parameters and operating characteristics of a corresponding LED module to which it is coupled, and dynamically configures itself to optimally drive the LED module according to the determined parameters and operating characteristics.

### SUMMARY OF THE INVENTION

The present invention, among other applications, is directed to solving the above-noted problems and addresses other problems, disadvantages, and limitations of the prior art. The present invention provides a superior technique for auto-configuring an LED driver to drive an LED module. In one embodiment, an apparatus for automatically characterizing and configuring a light-emitting diode (LED) lighting system is provided. The apparatus includes a driver, an identification element, and an exciter. The driver is configured to provide a plurality of constant currents within a first range, a plurality of first voltages within a second range, at a plurality of maximum power levels within a third range over a power signal and a return signal, where the driver is configurable to drive the power and return signals to provide one of the plurality of constant currents, one of the first plurality of first voltages, and one of the plurality of maximum power levels to comport with operating characteristics of an LED module. The identification element is coupled to the driver, and is configured to exhibit a unique frequency response to excitation by excitation signals generated exclusively over the power and return signals at second voltages less than a lower bound of the second range. The exciter is coupled to the identification element and the driver via the power and return signals, and is configured to generate the excitation signals, and is configured to determine the one of the plurality of constant currents, the one of the plurality of first voltages, and the one of the plurality of maximum power levels based upon the unique frequency response, and is configured to configure the driver to comport with the operating characteristics.

One aspect of the present invention contemplates an apparatus for automatically characterizing and configuring a light-emitting diode (LED) lighting system. The apparatus has an identification element and a driver/exciter module. The identification element is configured to exhibit a unique frequency response to excitation by excitation signals generated exclusively over a power signal and a return signal at first voltages less than a lower bound of a first range, where the unique frequency response indicates one of a plurality of constant currents in a second range, one of a plurality of second voltages in the first range, and one of a plurality of maximum power levels in a third range. The driver/exciter module is coupled to the identification element via the power and return signals, and is configured to provide the plurality of constant currents, the plurality of first voltages and a plurality of second voltages within the first range, at the plurality of maximum power levels within the third range over the power and return signals, and is configured to generate the excitation signals and to determine and drive the power and return signals with the one of the plurality of constant currents, the one of the plurality of second voltages, and the one of the plurality of maximum power levels to comport with operating characteristics of an LED module.

Another aspect of the present invention comprehends a method for automatically characterizing and configuring a light-emitting diode (LED) lighting system. The apparatus includes: via a driver, providing a plurality of constant currents within a first range, a plurality of first voltages within a second range, at a plurality of maximum power levels within a third range over a power signal and a return signal, where the driver is configurable to drive the power and return signals to provide one of the plurality of constant currents, one of the first plurality of first voltages, and one of the plurality of maximum power levels to comport with operating characteristics of an LED module; via an identification element coupled to the driver, exhibiting a unique frequency response to excitation by excitation signals generated exclusively over the power and return signals at second voltages less than a lower bound of the second range; and via an exciter coupled to the identification element and the driver via the power and return signals, generating the excitation signals, and determining the one of the plurality of constant currents, the one of the plurality of first voltages, and the one of the plurality of maximum power levels based upon the unique frequency response, and configured to configure the driver to comport with the operating characteristics.

### BRIEF DESCRIPTION OF THE DRAWINGS

These and other objects, features, and advantages of the present invention will become better understood with regard to the following description, and accompanying drawings where:

FIG. 1 is a block diagram illustrating an LED lighting system according to the present invention;

FIG. 2 is a timing diagram depicting a second embodiment of an auto-configurable LED lighting system according to the present invention; and

FIG. 3 is a block diagram featuring illustrating a third embodiment of an auto-configurable LED lighting system according to the present invention.

### DETAILED DESCRIPTION

Exemplary and illustrative embodiments of the invention are described below. In the interest of clarity, not all features of an actual implementation are described in this specification, for those skilled in the art will appreciate that in the development of any such actual embodiment, numerous implementation specific decisions are made to achieve specific goals, such as compliance with system-related and business related constraints, which vary from one implementation to another. Furthermore, it will be appreciated that such a development effort might be complex and time-consuming, but would nevertheless be a routine undertaking for those of ordinary skill in the art having the benefit of this disclosure. Various modifications to the preferred embodiment will be apparent to those skilled in the art, and the general principles defined herein may be applied to other embodiments. Therefore, the present invention is not intended to be limited to the particular embodiments shown and described herein, but is to be accorded the widest scope consistent with the principles and novel features herein disclosed.

The present invention will now be described with reference to the attached figures. Various structures, systems, and devices are schematically depicted in the drawings for purposes of explanation only and so as to not obscure the present invention with details that are well known to those skilled in the art. Nevertheless, the attached drawings are included to describe and explain illustrative examples of the present invention. The words and phrases used herein should be understood and interpreted to have a meaning consistent with the understanding of those words and phrases by those skilled in the relevant art. No special definition of a term or phrase (i.e., a definition that is different from the ordinary and customary meaning as understood by those skilled in the art) is intended to be implied by consistent usage of the term or phrase herein. To the extent that a term or phrase is intended to have a special meaning (i.e., a meaning other than that understood by skilled artisans) such a special definition will be expressly set forth in the specification in a definitional manner that directly and unequivocally provides the special definition for the term or phrase.

### Definitions

LED Module: Any configuration of LEDs from a single LED to a plurality of LEDs arranged in series or in parallel, and any combination thereof. An LED module may be disposed in the shape of a fluorescent tube (e.g., T5, T8, etc.), they may be disposed on a printed circuit board, or they may be disposed by other technique for mounting electronic components extant in the art.

Central Processing Unit (CPU): The electronic circuits (i.e., “hardware”) that execute the instructions of a computer program (also known as a “computer application” or “application”) by performing operations on data that include arithmetic operations, logical operations, and input/output operations.

Microprocessor: An electronic device that functions as a CPU on a single integrated circuit. A microprocessor receives digital data as input, processes the data according to instructions fetched from a memory (either on-die or off-die), and generates results of operations prescribed by the instructions as output. A general purpose microprocessor may be employed in a desktop, mobile, or tablet computer, and is employed for uses such as computation, text editing, multimedia display, and Internet browsing. A microprocessor may also be disposed in an embedded system to control a wide variety of devices including appliances, mobile telephones, smart phones, and industrial control devices.

Microcontroller: An electronic device that functions as a microprocessor, memory, and on a single integrated circuit. A microcontroller receives digital data as input from its programmable input/output peripherals, processes the data according to instructions stored in its memory, and generates results of operations prescribed by the instructions as output. A microcontroller may be employed in embedded systems and devices, and is employed control a wide variety of devices including appliances, mobile telephones, smart phones, and industrial control devices.

Microcode: A term employed to refer to a plurality of micro instructions. A micro instruction (also referred to as a “native instruction”) is an instruction at the level that a microprocessor sub-unit executes. Exemplary sub-units include integer units, floating point units, MMX units, and load/store units. For example, micro instructions are directly executed by a reduced instruction set computer (RISC) microprocessor. For a complex instruction set computer (CISC) microprocessor such as an x86-compatible microprocessor, x86 instructions are translated into associated micro instructions, and the associated micro instructions are directly executed by a sub-unit or sub-units within the CISC microprocessor.

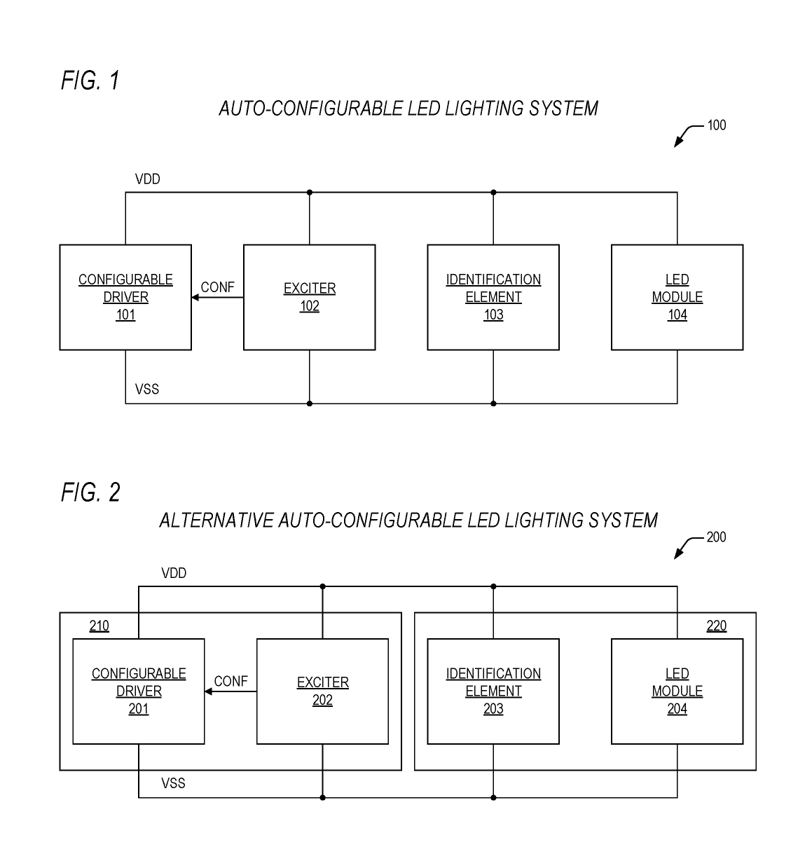

In view of the above background discussion on LED lighting and associated techniques employed within the art for provisioning of LED lighting modules and associated drivers, a discussion of the present invention will now be presented with reference to FIGS. 1-3. The present invention overcomes the above noted limitations and disadvantage, and others, by providing an auto-configurable LED lighting system, where a driver, after determining characteristics and operating parameters of a corresponding LED module within the LED lighting system, automatically configures itself to drive the LED module according to the determined characteristics and operating parameters.

One objective of the present invention to provide an LED lighting system for a class of LED modules having a substantial number of different characteristics and operating parameters, where the system according to the present invention automatically characterizes its LED module and configures its corresponding LED driver such that safe and reliable operation may ensue. In one embodiment, the system contemplates virtually all LED modules that are employed in present day offices and residences. Another embodiment comprehends a class of LED modules that are employed in large facilities such as, but not limited to, stadiums and arenas. A further embodiment considers a class of LED modules that are employed in special purpose equipment such as, but not limited to, microscopes and macro photographic lighting. Going forward, for clarity sake the present invention will be discussed in terms of an LED system that automatically configures drivers for LED modules employed in present day offices/residences, however, it is noted that the concepts disclosed herein may be employed without undue experimentation to address the other classes of modules noted above.

Referring to FIG. 1, a block diagram is presented depicting an LED lighting system 100 according to the present invention. The system 100 includes a configurable driver 101 that is coupled to an exciter 102 via a VDD signal (i.e. power) and a VSS signal (i.e., return), and that receives configuration control data via a configuration bus CONF. The driver 101 and exciter 102 are also coupled via VDD and VSS to an identification element 103 and to an LED module 104. As one skilled in the art will appreciate, in an LED lighting system VDD is generally controlled by the driver 101 to provide a prescribed constant current at a prescribed voltage to drive the LED module 104, where the current and voltage are applied, while not exceeding a prescribed maximum power limit, to forward bias one or more LED elements (not shown) within the LED module 104, thus resulting in light emissions of a prescribed color temperature at a prescribed illumination level.

The configurable driver 101 is capable of supplying a plurality of constant currents within a first range, a second plurality of voltages within a second range, at a plurality of maximum power levels within a third range, and may be configured by the exciter 102 via bus CONF to provide one of the plurality of constant currents, one of the second plurality of voltages, at one of the plurality of maximum power levels such that the configured characteristics and operating parameters comport with those required to safely and reliably control the LED module 104.

According to the present invention, a priori knowledge of the characteristics and operating parameters for the LED module 104 are employed to configure the identification element 103 to allow for determination thereof by the exciter 102 solely by providing signaling over VDD and VSS at voltage levels less than those required to forward bias elements within the module 104. No other signaling is required other than signaling over VDD and VSS for the exciter 102 to determine the characteristics and operating parameters from the identification element 103. In addition, the present invention contemplates a plurality of identification elements 103, each having a unique configuration that comports with a corresponding unique characteristics and operating parameters set for one or more LED modules 104 within the class, where the totality of identification elements 103 for the class covers all of the different characteristics and operating parameters sets for the LED modules 104 within the class.

In one embodiment, the identification element 103 is configured to exhibit a unique frequency response at the above noted signaling levels such that the corresponding unique characteristics and operating parameters may be determined by the exciter 102. In one embodiment, the identification element 103 comprises a resistor-inductor-capacitor (RLC) combination that exhibits the unique frequency response. In addition to the prescribed constant current, prescribed voltage, and prescribed maximum power, the identification element 103 may also be configured to convey additional data regarding the module 104 such as, but not limited to, the number of parallel LED strings in the LED module 104, where such information may be employed to determine when the LED module 104 may be failing or malfunctioning.

In one embodiment, the driver 101, exciter 102, identification element 103, and LED module 104 are coupled via VDD and VSS, where the coupling mechanism comprises conventional wiring within a conventional lighting fixture. Other coupling mechanisms are contemplated as well, to include, but not limited to, traces on printed circuit boards, and the like.

In one embodiment the exciter 102 is configured to electrically stimulate the identification element 103 and measure the frequency response (i.e., magnitude and phase of both voltage and current) of the identification element 103 to the stimulation. Once the unique frequency response is determined, the exciter 102 then transmits the selected characteristics and operating parameters for the LED module 104 to the configurable driver 101 over bus CONF, which in turn automatically configures itself to provide safe and reliable characteristics and operating parameters for the LED module 104.

The stimulation provided by the exciter 102 output may be provided in several configurations. In one embodiment, a continuous waveform can be employed. This continuous excitation can be swept in frequency while the response of the identification element is measured by the exciter 102. In another embodiment the exciter 102 may apply an impulse that excites the element 103 and its response measured. In another embodiment, the exciter 102 may apply random noise to the element 103 and its response measured. Other embodiments of the exciter 102 and identification element 103 are contemplated as well that employ voltages lower than required to forward bias elements within the LED module 104, and that exclusively employ the two interconnecting signals VDD, VSS.

Newer LED drivers typically have microcontrollers within the LED driver 102. In one embodiment, the implementation of the exciter 102 to provide both stimulation and response measurement will be disposed within microcode stored in a memory that provides for control of a microcontroller within the driver 101. Thus, the additional cost of implementation of the exciter 102 within the LED lighting system 100 is small if the same elements that are used during present day control of the LED module 104 are also used for stimulation of the identification element 103 by the exciter 102.

One advantage of the present invention is that the cost of the elements within the identification element 103 is negligible. In one embodiment the identification element comprises passive components, i.e. inductors, resistors and/or capacitors.

The information that represents the characteristics and operating parameters of the LED module 104 is conveyed in multiple ways from the identification element 103 to the exciter 102. In one embodiment, the magnitude of the response, voltage and/or current, at certain frequencies or frequency bands, is employed convey the information to the exciter 102. In another embodiment the phase relative to the excitation will convey the information. In another embodiment the time response of the voltage and/or current will convey the information.

Turning now to FIG. 2, a block diagram is presented illustrating a second embodiment of an auto-configurable LED lighting system 200 according to the present invention, where like named elements 201-204 function substantially in the same manner as those elements 101-104 of the LED lighting system of FIG. 1, the difference being that both the driver 201 and exciter 202 are physically disposed within a driver/exciter module 210, and the identification element 203 and LED module 204 are physically disposed within an auto-discoverable LED module 220. The driver/exciter module 210 according to the present invention is enabled to perform auto configuration and to drive any of a plurality of auto-discoverable LED modules 220 within a given class, as noted above. Advantageously, the system 200 of FIG. 2 provides for a single driver/exciter module 210 for the class such that any of the plurality of auto-discoverable LED modules 220 within the class may be driven, thus drastically lowering costs associated with stocking and installation.

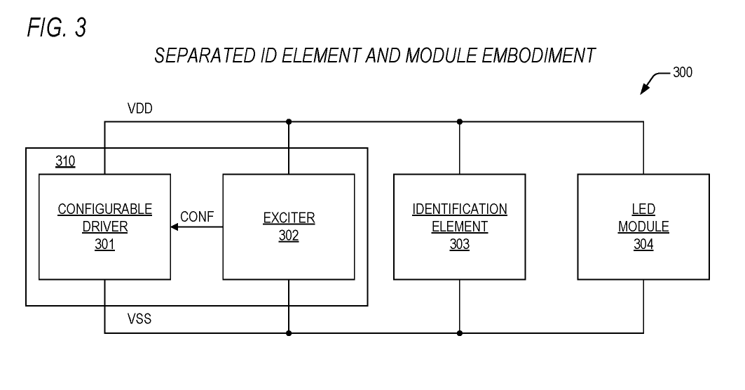

Referring now to FIG. 3, a block diagram is presented illustrating a third embodiment of an auto-configurable LED lighting system 300 according to the present invention, where like named elements 301-304 function substantially in the same manner as those elements 101-104 of the auto-configurable LED lighting system 100 of FIG. 1, the difference being that in the embodiment of FIG. 3, both the configurable driver 301 and exciter 302 are physically disposed within a driver/exciter module 310, and the identification element 303 and LED module 304 are physically separate elements from the driver/exciter module 310 and from each other. Advantageously, the system 300 of FIG. 3 provides for a single driver/exciter module 310 for the class such that any of a plurality of LED modules 304 within the class may be driven by selecting corresponding identification elements 303, thus drastically lowering costs associated with installation. And while stocking costs may be incrementally more than those of the system 200 of FIG. 2, the system 300 of FIG. 3 provides for upgrades of existing LED modules 304 from a non-discoverable to an auto-discoverable system 300 according to the present invention.

One advantage of the present invention is that auto-discoverable LED lighting mechanisms and methods are provided that are much less costly than that which has heretofore been provided. Because the LED driver/exciter envisioned by the present invention can determine its required operating parameters when it is connected to an LED module, the requirement for multiple product variations of an LED driver are substantially reduced. On the supply side, this decreases the cost of designing, manufacturing, stocking, transporting, and managing multiple variants of an LED driver. In the field, the cost associated with labor and human errors are virtually eliminated.

Furthermore, because the present invention enables different combinations of LED drivers and LED modules to be used regardless of their operating parameters, a field technician no longer needs to carefully match LED driver and LED module in a field maintenance scenario. This eliminates errors associated with the replacement of an LED driver and/or LED module in the field, as well as the inefficiency associated with procurement of a very specific LED driver and/or LED module.

Portions of the present invention and corresponding detailed description are presented in terms of software, or algorithms and symbolic representations of operations on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, or as is apparent from the discussion, terms such as “processing” or “computing” or “calculating” or “determining” or “displaying” or the like, refer to the action and processes of a computer system, a microprocessor, a central processing unit, or similar electronic computing device, that manipulates and transforms data represented as physical, electronic quantities within the computer system's registers and memories into other data similarly represented as physical quantities within the computer system memories or registers or other such information storage, transmission or display devices.

Note also that the software implemented aspects of the invention are typically encoded on some form of program storage medium or implemented over some type of transmission medium. The program storage medium may be electronic (e.g., read only memory, flash read only memory, electrically programmable read only memory), random access memory magnetic (e.g., a floppy disk or a hard drive) or optical (e.g., a compact disk read only memory, or “CD ROM”), and may be read only or random access. Similarly, the transmission medium may be metal traces, twisted wire pairs, coaxial cable, optical fiber, or some other suitable transmission medium known to the art. The invention is not limited by these aspects of any given implementation.

The particular embodiments disclosed above are illustrative only, and those skilled in the art will appreciate that they can readily use the disclosed conception and specific embodiments as a basis for designing or modifying other structures for carrying out the same purposes of the present invention, and that various changes, substitutions and alterations can be made herein without departing from the scope of the invention as set forth by the appended claims.

What is claimed is:

1. An apparatus for automatically characterizing and configuring a light-emitting diode (LED) lighting system, the apparatus comprising:
a driver, configured to provide a plurality of constant currents within a first range, a plurality of first voltages within a second range, at a plurality of maximum power levels within a third range over a power signal and a return signal, wherein said driver is configurable to drive said power and return signals to provide one of said plurality of constant currents, one of said first plurality of first voltages, and one of said plurality of maximum power levels to comport with operating characteristics of an LED module;
an identification element, coupled to said driver, configured to exhibit a unique frequency response to excitation by excitation signals generated exclusively over said power and return signals at second voltages less than a lower bound of said second range; and
an exciter, coupled to said identification element and said driver via said power and return signals, configured to generate said excitation signals, and configured to determine said one of said plurality of constant currents, said one of said plurality of first voltages, and said one of said plurality of maximum power levels based upon said unique frequency response, and configured to configure said driver to comport with said operating characteristics.

2. The apparatus as recited in claim 1, wherein said driver, said exciter, and said identification element are separately disposed within a lighting module comprising said LED module.

3. The apparatus as recited in claim 1, wherein said driver and said exciter are disposed within a driver/exciter module, and wherein said identification element and said LED module are disposed within an auto-discoverable LED module.

4. The apparatus as recited in claim 1, wherein said driver and said exciter are disposed within a driver/exciter module within a lighting module.

5. The apparatus as recited in claim 1, wherein said excitation signals comprise a continuous waveform.

6. The apparatus as recited in claim 1, wherein said excitation signals comprise an impulse.

7. The apparatus as recited in claim 1, wherein said identification element comprises a resistor-inductor-capacitor (RLC) combination that exhibits the unique frequency response.

8. An apparatus for automatically characterizing and configuring a light-emitting diode (LED) lighting system, the apparatus comprising:
an identification element, configured to exhibit a unique frequency response to excitation by excitation signals generated exclusively over a power signal and a return signal at first voltages less than a lower bound of a first range, wherein said unique frequency response indicates one of a plurality of constant currents in a second range, one of a plurality of second voltages in said first range, and one of a plurality of maximum power levels in a third range; and
a driver/exciter module, coupled to said identification element via said power and return signals, configured to provide said plurality of constant currents, said plurality of first voltages and a plurality of second voltages within said first range, at said plurality of maximum power levels within said third range over said power and return signals, and configured to generate said excitation signals and to determine and drive said power and return signals with said one of said plurality of constant currents, said one of said plurality of second voltages, and said one of said plurality of maximum power levels to comport with operating characteristics of an LED module.

9. The apparatus as recited in claim 8, wherein said driver/exciter module and said identification element are disposed within a lighting module comprising said LED module.

10. The apparatus as recited in claim 8, said identification element and said LED module are disposed within an auto-discoverable LED module within a lighting module.

11. The apparatus as recited in claim 8, wherein said excitation signals comprise a continuous waveform.

12. The apparatus as recited in claim 8, wherein said excitation signals comprise an impulse.

13. The apparatus as recited in claim 8, wherein said excitation signals comprise random noise.

14. The apparatus as recited in claim 1, wherein said identification element comprises a resistor-inductor-capacitor (RLC) combination that exhibits the unique frequency response.

15. A method for automatically characterizing and configuring a light-emitting diode (LED) lighting system, the apparatus comprising:
via a driver, providing a plurality of constant currents within a first range, a plurality of first voltages within a second range, at a plurality of maximum power levels within a third range over a power signal and a return signal, wherein the driver is configurable to drive the power and return signals to provide one of the plurality of constant currents, one of the first plurality of first voltages, and one of the plurality of maximum power levels to comport with operating characteristics of an LED module;
via an identification element coupled to the driver, exhibiting a unique frequency response to excitation by excitation signals generated exclusively over the power and return signals at second voltages less than a lower bound of the second range; and
via an exciter coupled to the identification element and the driver via the power and return signals, generating the excitation signals, and determining the one of the plurality of constant currents, the one of the plurality of first voltages, and the one of the plurality of maximum power levels based upon the unique frequency response, and configured to configure the driver to comport with the operating characteristics.

16. The method as recited in claim 15, wherein the driver, the exciter, and the identification element are separately disposed within a lighting module comprising the LED module.

17. The method as recited in claim 15, wherein the driver and the exciter are disposed within a driver/exciter module, and wherein the identification element and the LED module are disposed within an auto-discoverable LED module.

18. The method as recited in claim 15, wherein the driver and the exciter are disposed within a driver/exciter module within a lighting module.

19. The method as recited in claim 15, wherein the excitation signals comprise a continuous waveform.

20. The method as recited in claim 15, wherein the identification element comprises a resistor-inductor-capacitor (RLC) combination that exhibits the unique frequency response.
